(19) United States
(12) Patent Application Publication
(10) Pub. No.: US 2005/0212717 A1
(43) Pub. Date: Sep. 29, 2005

(54) Modular display device and tool for removing display modules

(75) Inventor: Erwin Baumstark, Kuppenheim (DE)

Correspondence Address: JANSSON, SHUPE & MUNGER & ANTARAMIAN, LTD, 245 MAIN STREET, RACINE, WI, 53403, US

(73) Assignee: Dambach-Werke GmbH

(21) Appl. No.: 11/079,041

(22) Filed: Mar. 14, 2005

(30) Foreign Application Priority Data
Mar. 23, 2004 (EP) 04 006 928.8

(51) Int. Cl. G09G 5/00

(52) U.S. Cl. 345/1.1

(57) ABSTRACT

A modular display device for optical signals includes a supporting frame and a plurality of display modules each having a module housing and a plurality of light emitting diodes integrated therein. The module housings are inserted into the supporting frame and are releasably attached thereto. The attachment of the module housings in the supporting frame is implemented by movable snap-in locking members that are structured for engaging respective holding elements disposed on at least two opposing side walls of each module housing. The snap-in locking members of adjacent side walls of different module housings are arranged to be offset with respect to each other.

### FIELD OF THE INVENTION

The present invention refers to a modular display unit for optical signals and to a tool for removing display modules from a supporting frame of a modular display device.

### BACKGROUND OF THE INVENTION

A display device is described in DE 199 51 348 A1, incorporated herein by reference. Such display device includes a display field formed of several identical display modules, wherein the pixels are arranged line-wise and column-wise and are controlled by a controller. The attachment of the individual module housings to the supporting structure is implemented by screwing an angular holder, which engages at the front side of the module housing, to the supporting structure. One disadvantage of such an attachment is particularly that the individual module housings cannot be arranged directly adjacent to each other and, therefore, a uniform display field, which is also suitable for all types of module-overlapping signal displays, is not created. Secondly, the attachment by use of screws requires a lot of time and is complicated, because it is necessary, particularly when removing modules, to simultaneously hold the module housings while releasing the screws so that these module housings do not fall out of the supporting structure. This further creates a safety risk to the worker in the case of display devices attached at a high altitude, e.g. across a motorway.

### SUMMARY OF THE INVENTION

It is the object of the present invention to provide a modular display device for optical signals, which is capable of displaying all possible types of large-area signal display designs even across the borders of the individual modules, while also providing for an especially simple and safe exchange of the individual modules.

According to an aspect of the invention, the attachment of the module housings in the supporting frame is realized using movable snap-in locking members, which can engage respective holding elements arranged at least on two opposing side walls of each module housing, wherein the snap-in locking members for adjacent side walls of different module housings are arranged to be offset with respect to each other.

Such a construction ensures that a safe support of the individual modules within the supporting frame is achieved, so that the assembly of modules to the frame may be carried out without the aid of mechanical tools and the disassembly of same may be simply performed using a suitable tool. Moreover, such structure makes it possible for the display surfaces of the individual module housings to directly adjoin one another, so that a continuous display unit is formed in which large signal display designs can be displayed across the boundaries of the individual modules without irregularities being produced in the overall picture.

According to another aspect, holding elements are preferably holding studs projecting from the side walls of the module housing, and snap-in locking members are snap-in tongues with recesses for receiving the holding elements, whereby a simple and safe attachment of the module housing in the supporting frame is implemented when inserting a module housing.

According to another aspect, the front portion of the snap-in tongues is preferably angled and projects from the side wall of a module housing to be fixed, thereby effecting a guide for the release tool while also increasing the leverage of same.

In a preferred embodiment, three snap-in locking members are provided for each module housing. Two of the snap-in locking members engage one side wall of the module housing, and one of the snap-in locking members engages the opposing side wall. Due to this asymmetric arrangement, an especially safe clasping of the module housing by the snap-in locking members is achieved.

In a preferred embodiment, the front sides of the module housings, which are formed by front plates slightly projecting over the side walls, directly adjoin one another so that a uniform, module-overlapping signal display is provided where irregularities in the boundaries do not occur.

It is especially preferred that oblong recesses are provided in the front plates, on a level of the holding elements in parallel with the respective outer edge of the front plate. In such a case, a suitable release tool can easily be inserted in the oblong recesses from outside without damaging the front plates.

Preferably, flexible tongues are provided to support the module housing on the supporting frame, the flexible tongues being formed integrally with the snap-in tongues, so that after releasing the snap-in tongues an outwardly directed force is exerted onto the module housing.

In yet another aspect, a tool for removing a module housing from the supporting frame of a modular display device includes a base plate with a handle attached thereto and a plurality of release members, arranged on two opposing sides of the tool and extending perpendicularly to the base plate, for releasing the movable snap-in locking members from the respective holding elements. The release members are arranged on a side of the tool, in offset fashion with respect to the respective release members on the other side of the tool, so that the advantage of a simple exchange of modules is realized by use of this tool.

In a preferred embodiment, a shoe for engagement into a holding stud is provided on the front end of each release member, allowing for a guided movement of the tool in an inner portion between two module housings that is not viewable from outside.

The release members are preferably inwardly oriented in a first, front central portion, so that a lever ramp is formed, on which the snap-in locking members are pressed outwardly when inserting the tool and are thus released from the holding elements.

The tool preferably comprises three release members, wherein two of the release members are arranged on one side of the tool and one release member is arranged on the opposite side, thereby ensuring a safe connection between the inserted tool and the module housing.

In a preferred embodiment, a leaf spring is arranged on an inwardly directed surface disposed in a second, rear central portion of the release member. The leaf spring is directed towards the inside and towards the base plate and is structured for engagement with the rear side of the front plate of the module housing. Such structure ensures that the leaf spring catches the module housing due to the barb effect of the leaf spring when pulling out the tool. The release members are preferably formed as thin sheet metal strips so that the recesses formed in the front plate require as little space as possible.

A lever for releasing a removed module housing from the tool is preferably arranged in the area of the handle to further facilitate handling of the module housing after disassembly.

### BRIEF DESCRIPTION OF THE DRAWING FIGURES

Further details, features and advantages of the present invention can be derived from the following description with reference to the drawing figures, wherein:

FIG. 1 shows a front view of a module display device having four modules, according to an exemplary embodiment of the invention;

FIG. 2 shows a top view of a module housing according to an exemplary embodiment of the invention;

FIG. 3 shows a front view of a front plate of the module housing of FIG. 2;

FIG. 4 shows a cross sectional view of a display device with two module housings inserted into the supporting frame;

FIG. 5 shows a perspective view of a partial portion of a display device with an empty insertion compartment for receiving a module housing, according to an exemplary embodiment of the invention; and

FIG. 6 shows a tool for releasing and removing a module housing from the display device, according to an exemplary embodiment of the invention.

### DETAILED DESCRIPTION OF PREFERRED EMBODIMENTS

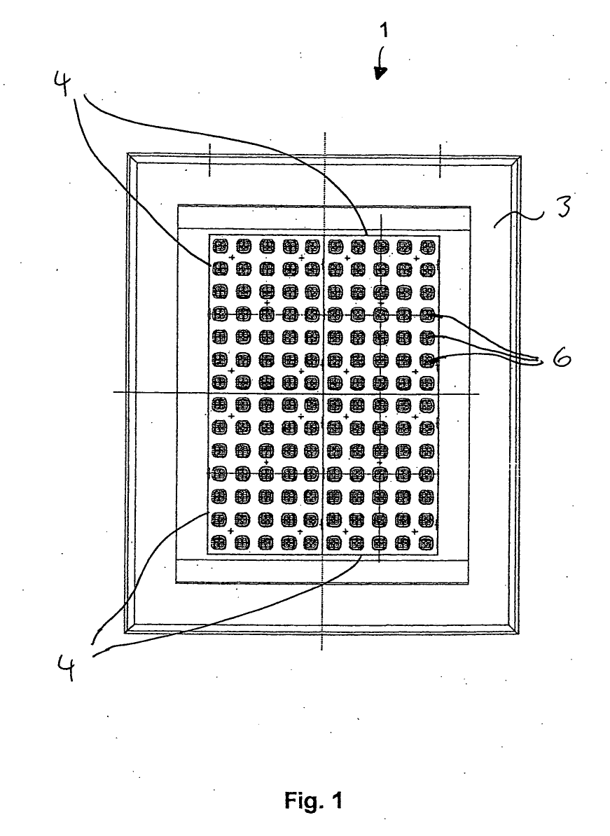

FIG. 1 shows a modular display device 1 having a supporting frame 3 and display modules 4 inserted into this supporting frame 3. In the embodiment shown, four display modules 4 are assembled to form a rectangular display field. However, any number of display modules 4 can be strung together. Each display module 4 has a rectangular display field, in which thirty-five signal fields are arranged in five columns and seven lines. Of course, a variation of the number and distribution of the signal fields 6 in the individual display modules 4 is also possible. Display device 1 may be attached via the supporting frame 3 to a supporting device (not shown), such as a pole, a signboard supporting bridge structure or another suitable equivalent for carrying display device 1.

FIG. 2 shows a preferred embodiment of a display module 4. The display module 4 has a module housing 8 that includes a front plate 10 with integrated signal fields 6 as well as a rear base body 12 with four side walls 14 and a rear wall 15. The front plate 10 and the base body 12 are preferably connected to one another by adhesion. The electrical/electronic units (not shown), including the light-emitting units which are controlled in a known manner by a central control unit (also not shown), are arranged in the interior of the base body 12. Holding elements 16 are arranged on at least two opposing side walls 14, holding elements 16 being formed, for example, as holding studs projecting from the respective side walls 14 of module housing 8. These holding studs 16 are arranged on side walls 14 at a location approximately one third of the depth of the module housing 8. In a preferred embodiment, two holding elements 16 are attached on one side wall and are spaced apart from one another, while only one holding element 16 exists in a center of the opposing side wall.

The base body 12 is preferably beveled on the side walls 14 in its rear portion towards the inside, which facilitates insertion of the module housing 8 into the insertion compartment provided for this purpose in the supporting frame 3. Moreover, four insertion pins 18 are preferably arranged as further guide and support aids on the rear wall 15 of the module housing 8, such insertion pins 18 engaging in respective recesses of the supporting frame 3, as will be explained later on. The front plate 10 preferably projects on the sides slightly outwardly over the base body 12 so that inserted ones of the front plates 10 of adjacent module housings 8 almost directly adjoin one another.

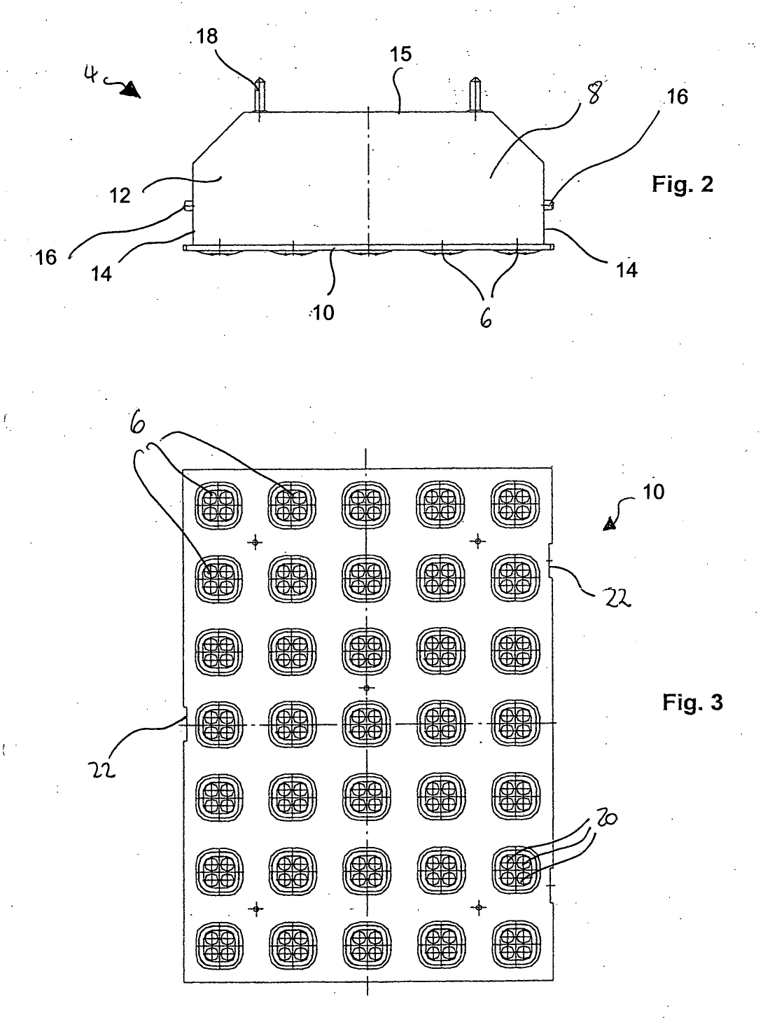

FIG. 3 shows a front plate 10. The front plate 10 comprises several signal fields 6, which are arranged in lines and columns. The signal fields 6 are each formed as integral cover units and are inserted into the openings of the front plate 10 provided for this purpose. A signal field 6 may include several, in this case four, lens elements 20, which are integrated into the cover unit and which serve for bundling the light, which is irradiated by a light source, preferably a light emitting diode arranged behind the front plate 10 in the interior of the base body 12. Such an arrangement causes the light from four LEDs to be bundled to one signal point, which leads to an especially high intensity of light.

Oblong recesses 22 are formed near the side edges of the front plate 10, the recesses being located on the same vertical level as the holding elements 16. These recesses 22 preferably extend directly from the edge of the front plate 10.

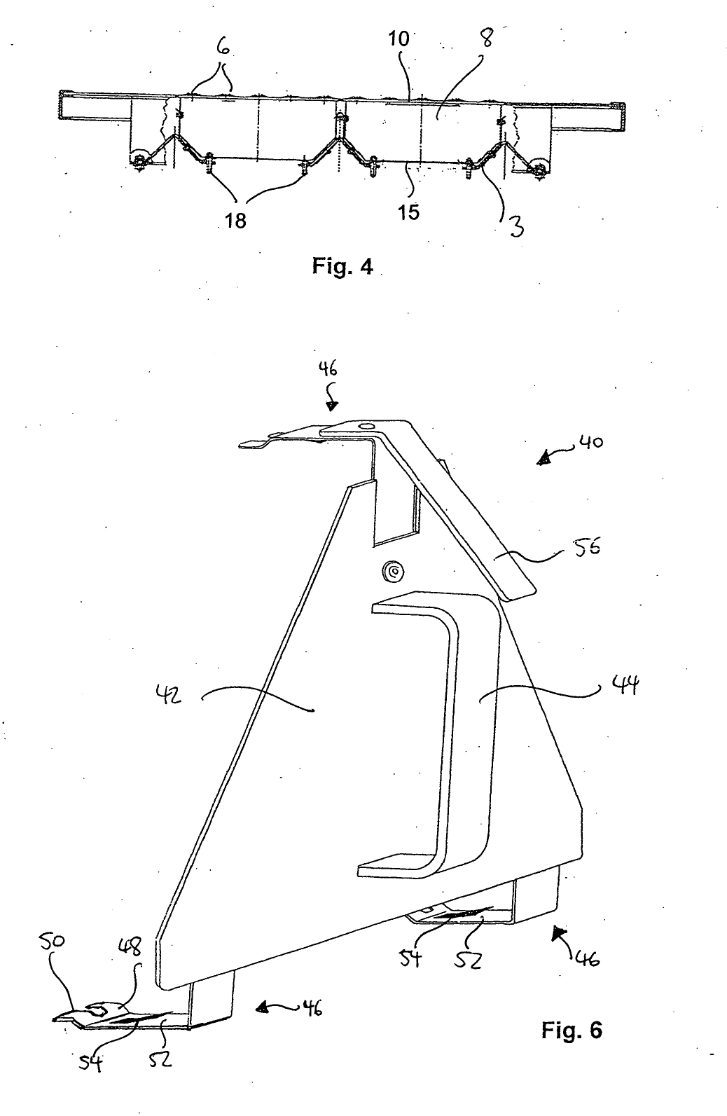

FIG. 4 shows a cross sectional view of two module housings 8 inserted and attached into the supporting frame 3. It can be seen that the two front plates 10 directly adjoin one another and the supporting frame 3 has a V-shaped section 23 between two insertion compartments, V-shaped section 23 having a shape adapted to abut the beveled part of the side walls 14 of the module housings 8.

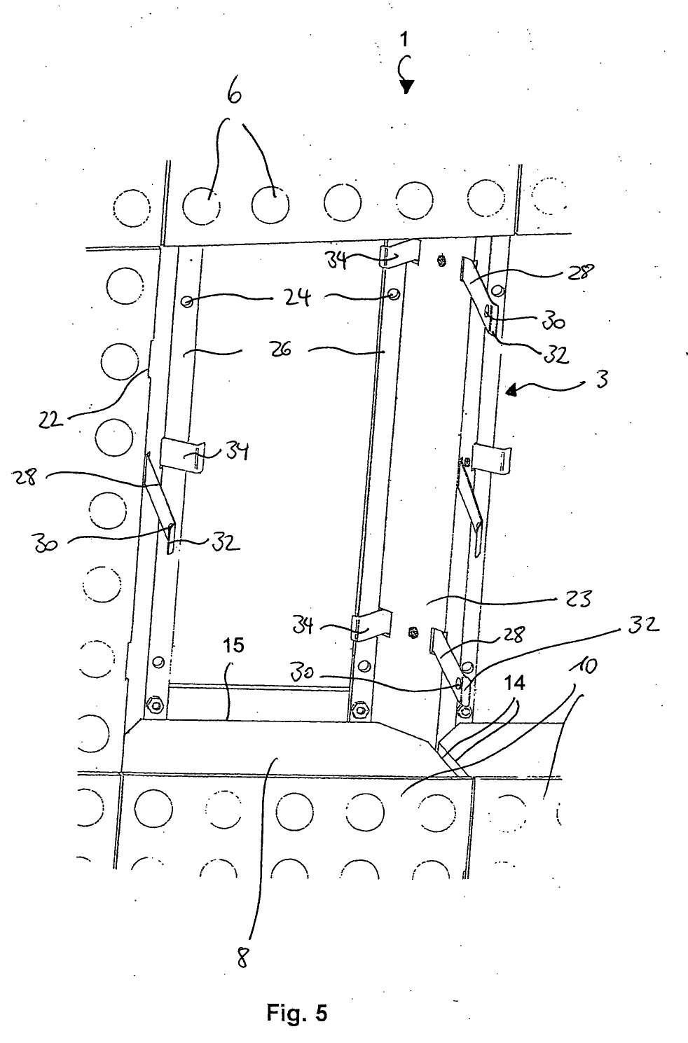

FIG. 5 shows in detail a portion of a display device 1 with several inserted module housings 8, the front plate 10 with the indicated signal fields 6 being visible. In the central portion of the drawing, an empty insertion compartment for a module housing 8 is shown to explain the attachment mechanism of the module housing 8 on the supporting frame 3. The vertically arranged V-shaped sections 23 of the supporting frame 3 can be seen, V-shaped sections 23 abutting the beveled side wall portions of the module housing 8 when the module housing 8 is inserted into the insertion compartment. The four passage holes 24 for receiving the insertion pins 18 of the module housing 8 can also be seen, the four passage holes 24 being arranged in rails 26 of the supporting frame oriented in parallel to the display surface.

Three snap-in locking members 28 serve for attaching an inserted module housing 8, the snap-in locking members 28 being formed in the present example as snap-in tongues attached at the V-shaped section of the supporting frame 3. The snap-in tongues have recesses 30 for receiving the holding studs 16 and are angled on their front edge section 32, i.e. they project from the side wall of the module housing to be fixed. The attachment of the snap-in tongues 28 on the supporting frame 3 is implemented usually by use of screws, rivets, and the like. The snap-in tongues 28 substantially extend perpendicularly with respect to the display surface, and the distance between snap-in tongues 28 of opposing sides basically corresponds to the width of the base body 12 of a module housing 8.

In the embodiment shown, one snap-in tongue 28 is provided for attaching the left side wall of the module housing 8, which is basically located on half of the level of the insertion compartment. To attach the opposing, right side wall of the module housing 8, two snap-in tongues 28 are respectively provided in the area of the upper and lower ends of the insertion compartment. This three-point attachment geometry uses a minimum of constructive effort and is especially suitable for a safe attachment of the module housing 8. Many other different arrangements with three or more snap-in tongues 28 per module housing 8 are also possible. However, it must be noted that the snap-in tongues 28 of side walls facing each other are preferably arranged asymmetrically, i.e. in a manner offset with respect to each other, since otherwise a direct stringing together of the module housings 8 would not be possible. Although this example shows the snap-in tongues 28 arranged left and right in the insertion compartment, it is also conceivable to arrange them in the top or bottom of the insertion compartment or also on all four sides of the insertion compartment.

The dimensioning of the module housing is almost freely selectable. Module housings with display fields of 210×150 mm, 320×230 mm or 455×325 mm are for instance suitable. Flexible spring tongues 34 to support the module housing 8 inserted can be provided in the rear portion of the insertion compartment, such spring tongues 34 being formed in this example integrally with the snap-in tongues 28.

FIG. 6 shows an exemplary tool 40 for releasing and removing a module housing 8 from a supporting frame 3 of a modular display device 1. The tool 40 has a substantially triangular base plate 42, to which a handle 44 is attached. In the area of the three corners, an extending release member 46 is provided for releasing the movable snap-in locking members 28 from the respective holding elements 16 of the module housing 8. Release members 46 are arranged extending substantially perpendicular to the base plate 42. The release members 46 are formed in the preferred embodiment as thin sheet metal strips, which project from the base plate 42 at a substantially right angle and which extend inwardly bent in a front central portion while being forced inwardly into the module housing. On the front end of the release members 46, a shoe 50 for engagement into the holding stud 16 of a module housing 8 is provided. The shoe 50 may include two tongues, which define a notch arranged between the tongues, the notch preferably enlarging from the inside towards the outer edge of the shoe 50. In the oblong section between the front central portion 48 and the base plate 42 the release member 46 includes a rear central portion 52. In this portion 52, a leaf spring 54 is arranged on an inwardly directed surface, the leaf spring projecting towards the inside at a small angle and extending in the rear direction towards the base plate 42. At least one rubber stopper is provided on the front side of the base plate 42 that cannot be seen in FIG. 6, to prevent damage to the holding studs 16 when inserting the tool 40.

The arrangement of the release members 46 corresponds to the spatial arrangement of the snap-in tongues 28 on the supporting frame 3 so that in the present example two release members are arranged on one side of the tool 40 and one release member 46 is arranged on the opposing side. Of course, it is also possible to select other geometries which correspond to the arrangement of the snap-in pins 28.

A lever 56 is arranged on each individual release member 46 to release the tool 40 from a module housing 8, such removal being effected as a result of the lever 56 being pressed and the thin sheet metal strip slightly bending upwards, which causes the leaf spring 54 to be lifted over the front plate 10 and thus, the module housing 8 is no longer engaged with the tool 40.

The insertion process of a module housing 8 into the modular display device 1 as well as the removal process will now be explained. The module housing 8 is inserted into the associated insertion compartment of the supporting frame 3, whereby the front sections 32 of the three snap-in tongues 28 are slightly pressed outwardly by the holding studs 16. The beveled portions of the side walls 14 of the module housing 8, which come into contact with the V-shaped sections 23 of the supporting frame 3, as well as the insertion pins 18, which penetrate through the passage holes 24, additionally serve as guides and thus enable an exact arrangement and engagement of the module housing 8. If the module housing 8 is completely inserted into the insertion compartment, the holding studs 16 latch into the recesses 30 of the snap-in tongues 28 so that the module housing 8 is safely anchored. Subsequently, the required electrical/electronic connections to the module housing 8 can be performed.

To remove a module housing 8 from the supporting frame 3, the release members 46 of the tool 40 are plugged and inserted into the recesses 22 of the front plate 10 provided for this purpose, whereby the leaf springs 54 are compressed. In the interior, the shoes 50 engage into the holding studs 16, and the snap-in tongues 28 are bent outwardly as a result of the action of the front central portion 48 of the release members 46 so that they are no longer engaged with the holding studs 16. At the same time, the leaf springs 54 when fully penetrating through the recesses 22 engage on the rear side of the front plate 10, and thereby serve as a barb for the outwardly directed removal movement of the tool. Thus, the module housing 8 is safely gripped by the tool 40 when removing it, and it can be pulled out without any further aid. The spring tongues 34, with their outwardly directed spring force, support the removal of the module housing 8.

As soon as the module housing 8 is removed from the supporting frame 3, the tool 40 can be released from the module housing by pressing the lever 56. Thus, a particularly simple installation and exchange of module housings 8 is possible.

While the principles of the invention have been shown and described in connection with specific embodiments, it is to be understood that such embodiments are by way of example and are not limiting.

1. A modular display device for optical signals, comprising:
a supporting frame having a plurality of movable snap-in locking members; and
a plurality of display modules, each display module comprising a module housing and a plurality of light emitting units integrated therein, each module housing having holding elements respectively arranged on at least two opposite side walls of said module housing,
wherein said module housings are insertable into said supporting frame and are detachably attached thereto by respective engagement of said movable snap-in locking members with said holding elements, and wherein said snap-in locking members of adjacent side walls of different module housings are arranged to be offset with respect to each other.

2. A display device as claimed in claim 1, wherein said holding elements are holding studs projecting from said side walls of said module housings.

3. A display device as claimed in claim 1, wherein said snap-in locking members are snap-in tongues with recesses for accommodating said holding elements.

4. A display device as claimed in claim 3, wherein said snap-in tongues each have an angled front section that extends from a respective one of said side walls.

5. A display device as claimed in claim 1, wherein three of said snap-in locking members are provided for each module housing, two of said three snap-in locking members being structured for engagement at one side wall of said module housing and the one other of said three snap-in locking members being structured for engagement at the opposite side wall.

6. A display device as claimed in claim 1, wherein front sides of said module housings are formed by front plates slightly projecting over said side walls, and wherein the front plates of adjacent module housings substantially directly adjoin one another.

7. A display device as claimed in claim 6, wherein, for each of said holding elements, an oblong recess is provided in said front plate at a same vertical height as said holding elements and in parallel to a respective outer edge of said front plate.

8. A tool for removing a module housing from a supporting frame of a modular display device, comprising a base plate, a handle attached thereto, and a plurality of releasing members structured for releasing movable snap-in locking members of said supporting frame from respective holding elements of said module housing, said releasing members being arranged on two opposing sides of said tool and extending essentially orthogonally with respect to said base plate, wherein at least one release members on one side of said tool is offset with respect to at least one release member on the other side of said tool.

9. A tool as claimed in claim 8, further comprising a plurality of shoes respectively disposed on a front end of each one of said release members and structured for engagement with a holding stud of said module housing, said shoes each being formed in an inwardly-offset, distal portion of the respective release member.

10. A tool as claimed in claim 8, wherein said plurality of release members consists of three release members, wherein two of said three release members are disposed on one side of said tool and one of said three release member is disposed on an opposite side of said tool.

11. A tool as claimed in claim 8, further comprising leaf springs respectively attached on an inwardly directed surface of each of said release members, said leaf springs projecting inwardly and towards said base plate.

12. A tool as claimed in claim 8, wherein said release members are formed as thin sheet metal strips.

13. A tool as claimed in claim 8, further comprising a lever disposed proximate said handle and structured for releasing a module housing secured by said release members of said tool.
